(19) United States
(12) Patent Application Publication
(10) Pub. No.: US 2012/0104090 A1
(43) Pub. Date: May 3, 2012

(54) CARD-READER APPARATUS

(75) Inventor: Thomas R. Gross, Rueschlikon (CH)

(73) Assignee: INTERNATIONAL BUSINESS MACHINES CORPORATION, Armonk, NY (US)

(21) Appl. No.: 13/253,392

(22) Filed: Oct. 5, 2011

(30) Foreign Application Priority Data
Oct. 29, 2010 (EP) 10189486.3

(51) Int. Cl. G06K 7/08; G06K 5/00; G07F 19/00

(52) U.S. Cl. 235/379; 235/380; 235/449

(57) ABSTRACT

A card-reader apparatus includes has a card interface for receiving data from a card presented to the card interface, a display, and a keypad having a plurality of keys for input of respective characters of user codes associated with cards presented to the card interface. The apparatus includes a controller for verifying a user code input for a card by processing the user code and the data received from the card by the card interface. The controller is adapted to generate a random mapping of user code characters to respective keys of the keypad, to control the display to indicate the mapping to a user, and to identify an input code character in accordance with the mapping. The apparatus is further adapted such that the mapping is displayed to the user with a limited viewing angle to inhibit unauthorized viewing.

### PRIORITY

This application claims priority to European Patent Application No. 10189486.3, filed 29 Oct. 2010, and all the benefits accruing therefrom under 35 U.S.C. §119, the contents of which in its entirety are herein incorporated by reference.

### BACKGROUND

This invention relates generally to a card-reader apparatus and, more particularly, to a card-reader apparatus adapted to foil so-called “card-skimming” attacks.

Card-skimming, or simply “skimming”, involves the malicious acquisition of information necessary to clone a bank card, identity card or similar user card and use the cloned card to make unauthorized transactions. To acquire the information in question, skimming attacks use mechanisms installed at the card-reader device. A typical card-reader has some form of card interface for receiving data from a user card presented to the device, together with a keypad for input by the user of a user code associated with the card. The device can determine from the received data and user code whether the correct user code has been input for the card. Only if the user code is verified does the card-reader permit a transaction to proceed. To produce a usable clone of a card, both the user code and the data received by the card interface must be obtained by the skimming process.

Bank ATMs (automated teller machines) are a prime example of card-reader devices vulnerable to skimming attacks. For ATMs, the skimming usually exploits the Static Data Authentication (SDA) with the magnetic strip of a bank card. In contrast to the more sophisticated Dynamic Data Authentication (DDA) with a cryptographically-enabled smart card chip, the SDA technique relies only on passive reading of the (secret) data, s, stored on the magnetic strip of the card. An attacker can acquire the secret data, s, by mounting his own magnetic strip reader adjacent the card-slot on the ATM. This is usually complemented by a pin-hole camera, mounted on or around the ATM, to record the user's PIN (personal identification number), p, entered on the ATM keypad. Alternatively, a fake keypad mounted over the ATM's genuine keypad can be used to sense the PIN entry. By thus obtaining the PIN code, p, and secret data, s, the attacker acquires all the secret information necessary for authenticating a cloned card and impersonating the genuine user in subsequent transactions.

Skimming of credit and debit cards is an increasingly costly problem for the finance industry. Banks could of course universally ban the SDA method and magnetic strips in favour of the more secure DDA method. However, this fundamental paradigm switch would be extremely expensive and difficult to manage since all ATMs world-wide would need to be updated. Skimming gangs operate internationally, harvesting card data in countries where SDA is mostly abandoned and using the data in countries where SDA is still the only method used. As banks want backwards compatibility for convenience of their travelling customers, the SDA loophole is not easily eliminated.

While ATMs are a particularly common target, other card reader systems are similarly vulnerable to skimming attacks. For example, point-of-sale card-reader terminals can be similarly targeted to obtain bank card details. Card-readers for other types of user card are also vulnerable. For example, attacks are possible against authentication terminals for reading identity cards such as national identity cards bearing personal data, healthcare or insurance cards etc., where the user enters a code at a terminal device which is verified against the card data. Another example is authentication terminals for secure-access systems where a user is required to present a card, and enter an associated security code, to gain access to a secure area or device.

Various systems have been proposed to counter skimming attacks. Some systems employ induction mechanisms to detect modifications to an ATM, and some feature elaborate methods using multiple sensors to detect interference. Other techniques modify the card-insertion process or generate temporary magnetic fields to disrupt operation of the illegal card interface. An overview of such anti-skimming techniques is given in “Attack of the Card Cloners”, Barwise et al., The Heise Security, http://www.h-online.com/security/features/Manipulated-ATMs-746193.html. These methods are expensive, have not been widely adopted and, most critically, have failed to stop skimming.

U.S. Pat. No. 5,428,349 discloses a password entry system in which a randomized matrix of alphanumeric characters is displayed to a user. A user scans the matrix and, using keys associated with respective columns of the matrix, indicates the column containing a first character of his password. The matrix is then refreshed and the process repeated until all characters of the password have been dealt with. Similar password randomization techniques are also well known in computing environments. Particular examples are discussed in “KLASSP: Entering Passwords on a Spyware Infected Machine Using a Shared-Secret Proxy”, Florencio et al., Proc. ACSAC '06, pp. 67-76, and “A Virtual Password Scheme to Protect Passwords”, Ming Lei et al., IEEE International Conference on Communications, 2008, pp. 1536-1540. Randomized screen keypads, whereby a computer user enters his password on a randomly-arranged keypad displayed on the computer screen, are also known for protecting Internet password entry against key-logger and Trojan horse spyware.

### SUMMARY

One embodiment of an aspect of the present invention provides card-reader apparatus, including a card interface for receiving data from a card presented to the card interface; a display; a keypad having a plurality of keys for input of respective characters of user codes associated with cards presented to the card interface; and a controller for verifying a user code input for a card by processing the user code and the data received from the card by the card interface, the controller being adapted to generate a random mapping of user code characters to respective keys of the keypad, to control the display to indicate the mapping to a user, and to identify an input code character in accordance with the mapping; wherein the apparatus is adapted such that the mapping is displayed to the user with a limited viewing angle to inhibit unauthorized viewing.

With card-reader apparatus embodying this invention, therefore, a random mapping of user code characters to respective keys of the character keypad may be generated and displayed to the user. This random mapping may be displayed with a limited viewing angle to inhibit unauthorized viewing. Viewing of this mapping other than by the user directly in front of the display, and in particular viewing by an unauthorized camera located to view the keypad, may therefore be inhibited. The apparatus may then identify an input code character in accordance with the random mapping as opposed to any character allocation indicated on the keypad itself. In this way, card-reader apparatus embodying the invention may protect the user code cryptographically. The random mapping, through its display with a limited viewing angle, may be conveyed to the user via a secure visual channel and thus becomes a new session secret for the transaction, known only to the user and the card-reader itself. Even if skimming equipment acquires the card data supplied to the card interface and, via a camera or fake keypad, logs the keys pressed by the user, this data will be useless to authenticate a cloned card, whether at another card-reader or in a later session of the same card-reader. Instead of the true user code, the skimmer may obtain only a random code from his attack. Embodiments of the invention can be readily implemented in existing card-reader systems. Embodiments of the invention may thus offer an efficient and inexpensive solution to the problem of card-skimming

Card-reader apparatus embodying the invention may be employed in a variety of devices including ATMs, point-of-sale terminals, and authentication terminals for various applications. Such authentication terminals include terminals for reading national identity cards, healthcare and insurance cards etc., where the user enters a code at a terminal device which is verified against the card data. Authentication terminals may also be employed in secure-access systems, providing physical security for doors, windows safes, etc., where a user is required to present a card, e.g. a key card, personnel card or other identity card, and enter an associated security code, to gain access to a secure area or device. Another application of authentication terminals is in computer two-factor authentication systems where authentication of a user for some purpose is based on two or more factors (e.g. a password, biometric information, and a user card such as a smart card or other token-bearing card), where again a user enters a code (typically a password) which is verified against the card data. According to an embodiment of the invention, a card may be defined as any electronic token that may transmit data to the interface of the reader apparatus.

In general, card-reader apparatus embodying the invention may be implemented in a self-contained terminal device or may be implemented by distributed apparatus, for example comprising a card-reader device and a separate device, such as a computer, which implements all or part of the controller functionality and with which the card-reader device can communicate in operation.

The particular form of the card-interface may vary in different embodiments and may be a contact interface, which engages the card directly, or a contactless interface such as a wireless radio interface. The particular data received from a card may of course vary from system to system and in general may comprise any data which can be used by the controller in verifying an input user code. The extent to which a card is active or passive in providing this data will depend on the type of card and the particular card interface employed. For instance, the data may simply be encoded in a magnetic strip on the card which is read by a magnetic strip reader of the apparatus. Alternatively, for example, the data might be stored in a memory device such as a chip which can supply the data to a communications interface of the apparatus. The particular processing performed by the controller to verify an input user code will also vary depending, for example, on the way in which the user code is related to the data read from the card for verification purposes.

While for many applications the user code associated with a card will be a PIN, the user code characters could in general be numbers, letters or any other symbols.

The apparatus may be adapted to display the aforementioned random mapping with a limited viewing angle through use of some physical mechanism associated with the display. In particular, the display may include a viewing angle limiter to limit the viewing angle for the display. In preferred embodiments, the viewing angle limiter comprises a screen foil. This foil, or film, may in general comprise one or more layers and may be operative to restrict the view angle in a variety of ways. Examples include louvre foils which have a louvre construction to restrict the view angle, and polarization foils which use light polarization to effect the angle restriction. Screen foils are well known for use on laptop computer screens to provide privacy against viewing by persons other than the laptop user, and similar technology can be employed in embodiments of this invention. As an alternative, however, the view angle limitation may be effected by the particular manner in which the information is displayed. In particular, in some embodiments the apparatus may be adapted to display a limited viewing angle hologram indicating the character/key mapping. This can be achieved using generally known holographic image generation techniques.

The character/key mapping might be indicated to the user in a variety of ways, but particularly preferred embodiments are adapted to display a representation of the keypad, with user code characters indicated for respective keys thereof, to indicate the mapping to a user. This is a simple and easily-understood mechanism for representing the mapping to the user.

The random mapping of characters to keys can be generated as required by the controller, e.g., in response to one or more trigger events such as a time event and/or card input or key input. While various alternatives can be envisaged here, the controller is preferably adapted to generate a the mapping at least for each user code to be input via the keypad, and possibly for each user code character to be input via the keypad. That is, a new mapping may be generated for each session and applied for the entire user code, or a new mapping might be generated for each character of the user code. In addition, in some embodiments the controller may be selectively operable in a “secure mode”, in which the random mapping is performed, and an “ordinary mode” which does not employ random mapping. In particular, when operating in the secure mode, the controller generates the random mapping, controls the display to indicate the mapping and identifies an input code character in accordance with this mapping as described above. In the ordinary mode, no re-mapping of characters to keys is performed, the user inputs his code in the usual way and the controller simply identifies an input code character in accordance with the user code characters indicated on the keypad itself. Selection of the operating mode could be under control of the apparatus provider or the user. In particular, the controller may select an operating mode in response to a mode selection indication for a user. Such a mode selection indication could be input, for example, via the keypad, e.g. in response to a query displayed to the user, or might be stored as a user preference on the card and indicated in the data supplied on presentation of the card to the card-reader.

Respective further embodiments of further aspects of the invention provide an automated teller machine, a point-of-sale terminal and an authentication terminal each comprising card-reader apparatus according to embodiments of the first aspect of the invention.

Another embodiment of an aspect of the present invention provides an electronic token-reader apparatus including a token interface for receiving data from a token presented to the token interface; a display; a keypad having a plurality of keys for input of respective characters of user codes associated with tokens presented to the token interface; and a controller for verifying a user code input for a token by processing the user code and the data received from the token by the token interface, the controller being adapted to generate a random mapping of user code characters to respective keys of the keypad, to control the display to indicate the mapping to a user, and to identify an input code character in accordance with the mapping; wherein the apparatus is adapted such that the mapping is displayed to the user with a limited viewing angle to inhibit unauthorized viewing.

Preferred embodiments of the invention will now be described, by way of example, with reference to the accompanying drawings in which:

### BRIEF DESCRIPTION OF THE FIGURES

FIG. 1 is a schematic representation of an ATM incorporating card-reader apparatus embodying the invention;

FIG. 2 indicates steps of a card verification process performed by the ATM of FIG. 1;

FIG. 3 illustrates display of a random character/key mapping in the FIG. 1 ATM; and

FIG. 4 shows the protocol flow in operation of the ATM under a skimming attack.

### DETAILED DESCRIPTION OF THE FIGURES

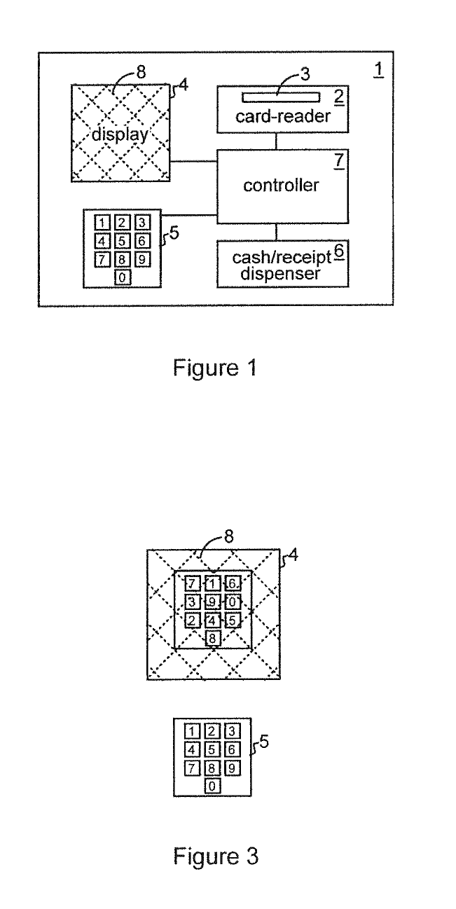

FIG. 1 is a schematic block diagram of an ATM embodying the invention showing the key elements involved in the operations to be described. The ATM 1 has a card interface in the form of a magnetic strip reader 2 for reading data from the magnetic strip of a bank card inserted in a card-slot 3. The ATM has a display 4 for displaying information to a user and a PIN keypad 5. The keypad 5 has a plurality of keys, here labelled 0 to 9, for input of respective digits of user PIN codes. A cash/receipt dispenser of the ATM is indicated generally at 6. In addition, the ATM includes a controller 7 comprising control logic for implementing the controller functionality to be described. Controller 7 controls operation of ATM 1 generally and implements the various steps of a card verification process detailed below. The logic of controller 7 could be implemented in general by hardware, software or a combination thereof but is conveniently implemented by a computer programed by software to perform the functions described. (The term “computer” is used here in the most general sense and includes any device, component or system having a data processing capability for implementing a computer program). Suitable software will be apparent to those skilled in the art from the description herein. In this embodiment, the display 4 includes a viewing angle limiter to limit the viewing angle of the display and inhibit unauthorized viewing of information displayed to the user. The viewing angle limiter here is a screen foil 8, indicated by the hatched lines in the figure, which is built into the display and extends over the area of the display screen. Screen foil 8 may employ a variety of techniques, such as a louvre construction or light polarization films, to effect the angle limitation and can be implemented by a foil generally similar to those known for use as privacy screens for laptop computers. The effect of foil 8 is to restrict the view angle such that viewing of displayed information other than by the user standing directly in front of the display is inhibited. In particular, viewing by a camera mounted illegally on the ATM to monitor the keypad, as required in a skimming attack, is inhibited. Effectiveness of this view restriction is facilitated by the separation of keypad and display typical to card-reader systems. In a typical ATM 1, for example, display 4 and keypad 5 are set apart from one another and are often orientated at different angles for convenience of user operation.

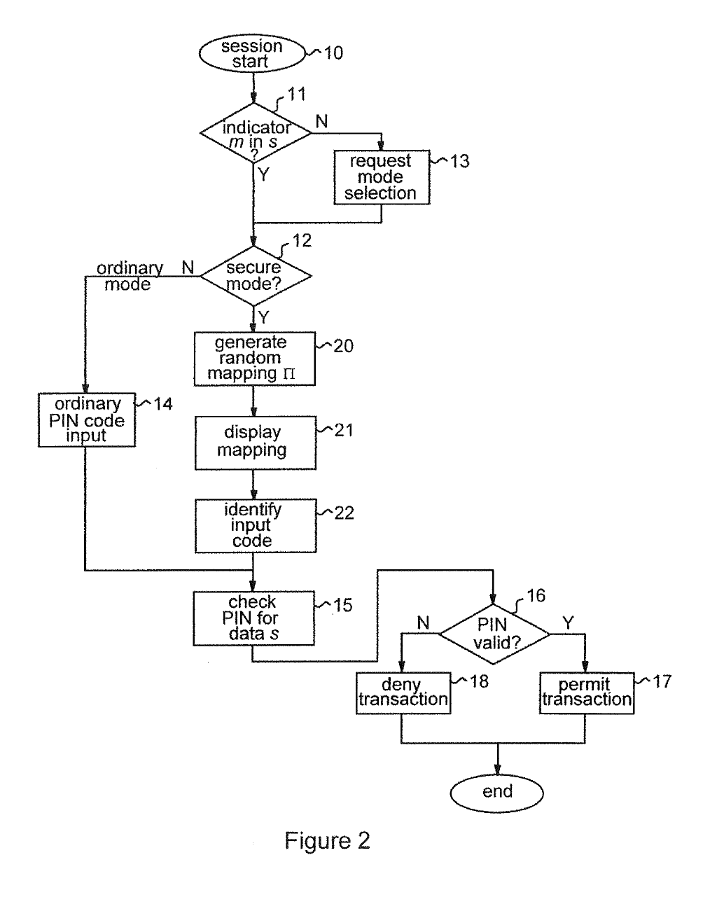

In operation, a user wishing to perform a transaction at ATM 1 presents his bank card to magnetic strip reader 2 by insertion in slot 3 of the ATM. The magnetic strip of such a bank card encodes secret data, s, which is related, via a predetermined algorithm, to the PIN code, p, associated with that card and supplied to the user by the card provider. The secret data, s, may also include a mode selection indicator, m. This indicator, m, which may be a simple flag, indicates the user's previously-decided preference for using ATM 1 in either a secure mode or an ordinary mode as described further below. The card data, s, and user PIN, p, are used in a card verification process which is performed by controller 7 before permitting a transaction to proceed. The key steps of this verification process are indicated in the flow chart of FIG. 2.

The user session begins, as indicated by step 10 in FIG. 2, on insertion of the card in magnetic strip reader 2 of the ATM. The secret data, s, read from the card is supplied by reader 2 to controller 7. In decision step 11 the controller determines if the data s contains a mode selection indicator m as described above. If so, (“Yes” (Y) at step 11), then in decision step 12 the controller determines if the mode selection indicator m signifies the secure mode of operation. If no mode selection indicator m is stored on the card, (“No” (N) at decision step 11), then operation proceeds to step 13 in which controller 7 supplies a mode-selection query to display 4 for display to the user. The query asks the user to select either the secure mode or the ordinary mode for the verification operation. The user's selection may be input via keypad 5 or, more typically, by using additional input keys (not shown) adjacent display 4 for selecting displayed options. Operation then proceeds to decision step 12 as before.

If the controller determines that the secure mode has not been selected at step 12, then operation proceeds in the ordinary mode and the ensuing verification process is conducted in conventional manner. Hence, in step 14 of the process the user is invited, by message on display 4, to enter his PIN, and the PIN is entered in the usual way on keypad 5 by successively pressing the keys marked with respective digits of the PIN. In step 15, controller 7 processes the entered pin p and card data s in accordance with the predefined algorithm to determine if the correct pin p has been entered for the card. If the PIN is verified in decision step 16 then the controller authenticates the user and permits the user transaction to proceed as indicated by step 17 in the figure. The card verification process is then complete. If the PIN is deemed invalid at decision step 16, then the user may be given one or more further opportunities (not represented in the figure) to enter a correct PIN. Assuming the correct PIN is not entered, then at step 18 the user authentication is deemed to fail and the transaction is not permitted to proceed. The user's card may be retained in the ATM in this case.

Returning now to decision step 12, if the secure mode is selected here, then the controller commences the secure mode operation in step 20 of the process. Here, the controller generates a random mapping of user code characters (here digits 0 to 9) to respective keys of the keypad 5. In particular, controller 7 selects a fresh, uniformly-chosen, random permutation of the keypad 5. This permutation is denoted here by π→shuffle([0,9]) where shuffle( ) is a standard random permutation algorithm over finite sets. Such algorithms are well known in the art, particular examples being a Fisher-Yates algorithm (see, for example “Statistical tables for biological, agricultural and medical research” (3^{rd} ed.), Fisher, R. A., Yates, F., Oliver & Boyd, London, 1938, pp. 26-27) and a Durstenfeld algorithm (see, for example “Algorithm 235: Random permutation”, Durstenfeld, Richard, Communications of the ACM 7 (7): 420, 1964). In step 21, controller 7 controls display 4 to indicate the new character/key mapping by displaying the permutation π as a picture of the keypad 5 with the new digit assignments indicated on the keys in the picture. FIG. 3 is a schematic illustration of the display 4 and keypad 5 showing the view seen by the user. Note that the screen foil 8 inhibits unauthorized viewing of the new keypad permutation here. The user then inputs the digits of his PIN on keypad 5 using the displayed digit/key mapping, ignoring the digits actually marked on the keys themselves. The actual digits input by the user in this process are identified by the controller in step 22 in accordance with the mapping π. When PIN entry has been completed in this way, the card verification operation proceeds to step 15 and continues as already described.

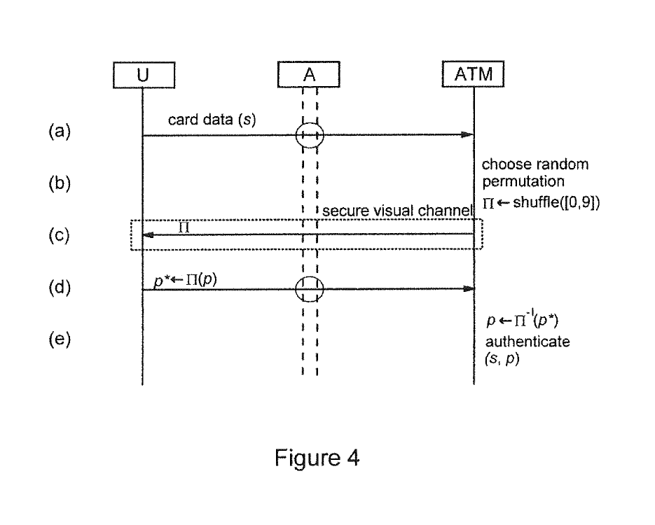

The protocol flow diagram of FIG. 4 illustrates how the secure mode of operation foils a skimming attempt by an attacker “A”, indicated at the centre of the figure, in the interaction between the user “U” on the left of the figure and the ATM 1 on the right. In the first stage of the information flow indicated by step (a) in the figure, the card data s is supplied to the ATM 1 and is assumed to be read by attacker A. Step (b) corresponds to generation of the random permutation π by controller 7. Step (c) corresponds to display of the randomized keypad to the user U. In this step, the action of screen foil 8 provides a secure visual channel between the ATM and user U so that only the user U can see the new keypad permutation. The attacker A does not, therefore, acquire the permutation π. In step (d) the user presses the keys of the PIN pad according to the positions of the randomized number arrangement on the display. This creates a randomized PIN p* which is given by p* →π(p). The randomized PIN p* is acquired by attacker A in the usual way through viewing or sensing the keystrokes on keypad 5. In step (e) the controller can identify the true pin p by inverting the randomization on input p* with the inverted permutation π⁻¹, i.e. p→π⁻¹(p*), and authenticates the user based on data pair (s, p) as described above. However, the visually secure channel employed in step (c) ensures that the random permutation π is secret to the user and the ATM. Given that π is uniformly random, the permutation p* of PIN p will also be uniformly random. Therefore, p* does not leak any information to the adversary A. This means that p* does not increase the a posteriori knowledge of the adversary (the a priori knowledge of the attacker is equal to his a posteriori knowledge which is a sufficient condition for information-theoretical security) and will be completely useless in a skimming attack. As π is freshly chosen in each ATM session, the probability of a collision is sufficiently small for all practical purposes.

It will be seen that, in contrast to prior anti-skimming proposals which seek to prevent reading of the magnetic strip data s, the above system addresses the skimming problem orthogonally by protecting the PIN p cryptographically. The system provides for cryptographic blinding of the PIN entry, protecting PIN entry by a uniformly chosen random permutation and ensuring an adversary can only obtain a random number from his attack, not the randomization function itself. The randomization function (π) thus constitutes a new session secret for an ATM transaction known only to the ATM and the user. Even if the adversary is able to obtain the card data s and the randomized PIN p*, this data will be completely useless for authentication as the user at another ATM or in another session of the same ATM. This holds for all ATMs worldwide, no matter whether they use the old PIN authentication or the presently disclosed method.

The simple and efficient anti-skimming system described can be implemented at low cost, and existing ATMs can be readily updated to implement the features described. For example, existing ATMs can be updated simply by a small software update to controller 7 and installation of a screen foil in display 4. The system can of course be combined with other protection schemes, such as induction methods, to additionally protect the card data s if desired.

Various modifications can be envisaged to the exemplary embodiment described above. For example, while the embodiment described can perform mode selection (secure or ordinary mode) based on an indication m stored on the card (step 11 of FIG. 2) or on user input (step 13), some embodiments may permit mode selection based on only one of these methods. Other embodiments may not provide for mode selection. That is, the apparatus may operate in the secure mode for all sessions. In these embodiments, it may be desirable to re-label the character keypad 5, e.g. to remove all character indications, to minimize the possibility of confusion.

While the controller 7 chooses a random mapping applicable to the entire PIN entry in the above system, in other embodiments the mapping may be dynamically re-chosen more frequently, e.g. after each digit is entered. At any time there is therefore a 1:1 mapping of code characters to keys but this mapping is random and periodically changed by the controller. In addition, though a display of the type shown in FIG. 3 is preferred as a particularly clear and simple representation of the mapping, other ways to indicate a character/key mapping pictorially can be readily envisaged.

Alternative viewing angle limitation mechanisms may be employed in other embodiments. For example, instead of a physical mechanism such as screen foil 8, the manner of display may be used to restrict the view angle. A particular example here is the use of a limited viewing angle hologram to display the randomized keypad.

Although the card-reader is an ATM in the above embodiments, apparatus embodying the invention can be applied to similar advantage in various other card-reader systems as already discussed. Many other changes and modifications can be made to the exemplary embodiments described without departing from the scope of the invention.

What is claimed is:

1. A card-reader apparatus, comprising:
a card interface configured to receive data from a card presented to the card interface;
a display;
a keypad having a plurality of keys configured to receive input of respective characters of user codes associated with cards presented to the card interface; and
a controller configured to verify a user code input for a card by processing the user code and the data received from the card by the card interface, the controller being adapted to generate a random mapping of user code characters to respective keys of the keypad, to control the display to indicate the mapping to a user, and to identify an input code character in accordance with the mapping;
wherein the apparatus is adapted such that the mapping is displayed to the user with a limited viewing angle to inhibit unauthorized viewing.

2. The apparatus as claimed in claim 1, wherein the display includes a viewing angle limiter to limit the viewing angle for the display.

3. The apparatus as claimed in claim 2, wherein the viewing angle limiter comprises a screen foil.

4. The apparatus as claimed in claim 1, wherein the apparatus is adapted to display a limited viewing angle hologram indicating the mapping.

5. The apparatus as claimed in claim 1, the apparatus being adapted to display a representation of the keypad, with user code characters indicated for respective keys thereof, to indicate the mapping to a user.

6. The apparatus as claimed in claim 1, wherein the controller is adapted to generate the mapping at least for each user code to be input via the keypad.

7. The apparatus as claimed in claim 1, wherein the controller is adapted to generate the mapping for each user code character to be input via the keypad.

8. The apparatus as claimed in claim 1, wherein the card interface comprises a magnetic strip reader.

9. The apparatus as claimed in claim 1, wherein user code characters are indicated on the keypad for respective keys thereof, and wherein the controller is selectively operable in a secure mode, wherein the controller generates the random mapping, controls the display to indicate the mapping and identifies an input code character in accordance with the mapping, and an ordinary mode wherein the controller identifies an input code character in accordance with the character indications on the keypad.

10. The apparatus as claimed in claim 9, wherein the controller is adapted to operate in one of the ordinary or secure modes in response to a mode selection indication for a user.

11. A terminal device comprising an apparatus as claimed in claim 1.

12. A card-reader apparatus as claimed in claim 1 for use in an automated teller machine.

13. An automated teller machine including the card-reader apparatus as claimed in claim 12.

14. A point-of-sale terminal comprising a card-reader apparatus as claimed in claim 1.

15. An authentication terminal comprising a card-reader apparatus as claimed in claim 1.
